(19) United States
(12) Patent Application Publication
(10) Pub. No.: US 2017/0302512 A1
(43) Pub. Date: Oct. 19, 2017

(54) UNIVERSAL CONTROL AND MONITORING OF SECURITY SYSTEMS AND SECURITY COMPONENTS

(71) Applicant: Observables, Inc., Santa Barbara, CA (US)

(72) Inventors: Ronald Richard Gans, Santa Barbara, CA (US); Abraham M. Schryer, Santa Ynez, CA (US)

(21) Appl. No.: 15/488,128

(22) Filed: Apr. 14, 2017

Related U.S. Application Data
(60) Provisional application No. 62/322,352, filed on Apr. 14, 2016.

(51) Int. Cl. H04L 12/24

(52) U.S. Cl. CPC H04L 41/0803; H04L 41/22

(57) ABSTRACT

There is disclosed a generalized security system that includes a local system, a mobile device application, and a server that is accessible via the mobile device application and a browser. The local system contains a microprocessor, communications components and related software all of which enable communications with the server and external components coupled with the local system. The local system software and server software combine with the mobile application and website interface to enable a user to monitor, configure, and control security components coupled with the local system and the local system itself via the server. The system replaces multiple disparate control devices with a single, configurable device and system. The system integrates multiple disparate devices and systems from multiple manufacturers

### RELATED APPLICATION INFORMATION

This patent claims priority from the provisional patent application 62/322,352 filed Apr. 14, 2016, which is incorporated by reference herein in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to residential and commercial security systems and components, and connecting, managing, monitoring and control of those systems and security components.

### Description of the Related Art

Residential and commercial security installations involve a wide variety of communication protocols, sensor configurations, controller configurations, and electrical parameters, for example, operating voltages and end of line resistances. This results in the existence of multiple specialty products with a lack of universal compatibility. This incompatibility causes challenges for system installers, security monitoring companies, hardware manufacturers, and software designers. In practice, security professionals use a large variety of disparate products, tools and systems to address the many requirements of their customers. However, integration of the products, tools and systems is made difficult by the incompatibilities described above. There is no system that is simple to install, configure, and use that manages these incompatibilities among security products, tools and systems.

### DESCRIPTION OF THE DRAWINGS

FIG. 1 is a block diagram of an environment in which the generalized security system described herein operates.

FIG. 2 is a block diagram of a general software configuration of the generalized security system described herein.

FIG. 3 is a block diagram of an example local system controller board that implements a portion of the generalized security system described herein.

FIG. 4 is a flow chart of actions taken in the generalized security system described herein.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

A generalized security system (GSS) that includes a local system including a programmable networked circuit board and local software, a mobile-device application, and a server-based Internet web site accessible via the mobile application and a browser is described herein. The local system includes a circuit board that contains a microprocessor, the local software, network communications components and related software all of which enable inputs received from the server software and external components to be sent to the microprocessor, and outputs created from the microprocessor to be sent to the server software and external components. The local and server software included in the GSS combine with the mobile application and website interface to enable a user to configure security components and automation software coupled with the local system. This alleviates the time consuming and monetary expense of embedded software development formerly necessitated by incompatible disparate security components, devices and systems. The GSS integrates multiple disparate devices and systems from multiple manufacturers with a single, configurable system, namely the GSS local system. The GSS may replace multiple disparate control systems from multiple manufacturers with a single, configurable device that is coupled with and communicates with the multiple disparate systems as well as devices, namely the GSS local system. The GSS as a whole and the local system in particular serve as a gateway providing information from, configuration of and communication between multiple disparate devices and components from multiple manufacturers. Since the GSS local system is programmed via metadata sent by the GSS server describing state engine configuration and that information only comes from one or more known GSS servers the GSS system is more secure than one that accepts arbitrary inbound remote connections and code deployments.

Description of Apparatus

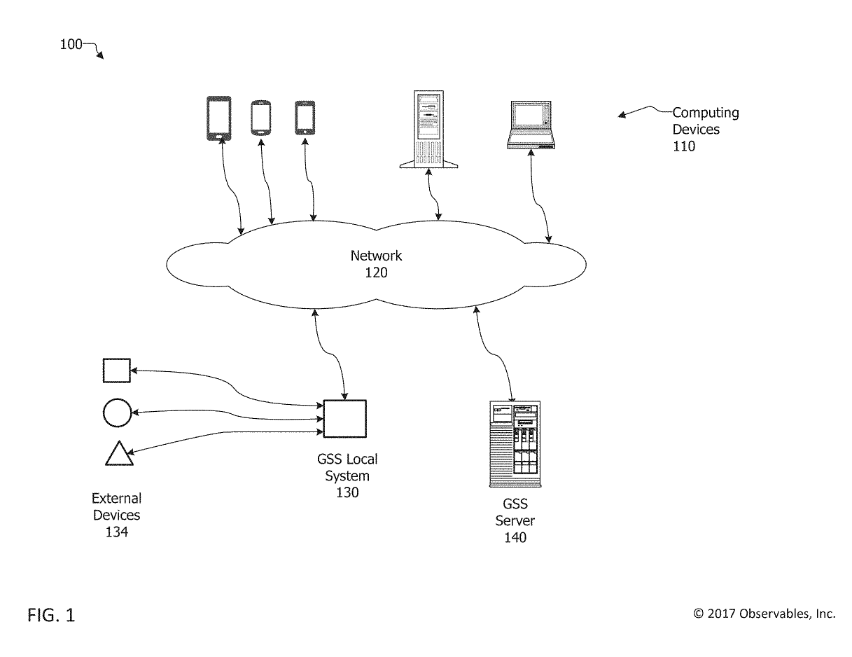

Referring now to FIG. 1, there is shown a block diagram of an environment 100 in which the generalized security system (GSS) described herein operates. The GSS includes a server 140 running GSS server software that provides a website and mobile application support to users on computing devices 110 over network 120. Users of the GSS control, manage and monitor external security system components and devices 134 and security systems external to a GSS local system 130 by accessing the GSS server 140 via computing devices 110 using a web interface provided by the GSS server 140 or a mobile application supported by the GSS server 140. The GSS server 140 takes high level commands, configuration and other information provided by users via their computing devices 110 over network 120 and sends it to the GSS local system 130 in a lower level command format unique to the GSS. The GSS local system 130 performs the actual control, monitoring and configuration of the external devices 134 and external systems and sends status information, external device data and other information to the GSS server 140 which provides alerts, security system external device data and other information via the web interface or app interface over network 120 to the users at computing devices 110.

A computing device 110 as used herein refers to any device with a processor, memory and a storage device that executes instructions including, but not limited to, personal computers, server computers, computing tablets, smart phones, portable computers, and laptop computers. These computing devices may run an operating system, including, for example, variations of the Linux, Android, Microsoft Windows, Apple iOS and Apple Mac operating systems.

The GSS server 140, computing devices 110 and GSS local system 130 communicate through a network 120. The network 120 comprises one or more public and/or private data networks, and other networks and sub-networks, and may include or be the Internet. The network 120 may also include or access cellular telephone and land line telephone networks, may include satellite links and microwave transmission links, and may be wired and wireless or a combination. The network 120 includes additional devices, not shown, such as routers, switches, firewalls, multiplexors and other networking equipment that enable and enhance network communications. Additional specialized servers such as application servers, database servers, and others may be coupled with or included GSS 100 and/or may be accessed by the GSS server 140 over network 120. Although only GSS server 140 and one GSS local system 130 are shown, multiple GSS servers 140 and multiple GSS local systems 130 may be involved in this environment. In addition, third party central monitoring station servers (not shown) may be coupled with the network 120 so that status information concerning external components and external systems may be communicated to and from the GSS server 140 and/or the local system 130. Similarly, the GSS server 140 and/or the local system 130 may communicate GSS system status as well as external components and external systems status and other information to the third party central monitoring station servers (not shown).

The methods described herein may be implemented on one or more server computers referred to herein as GSS server 140, one or more GSS local systems 130 running GSS local system software, and multiple computing devices 110 accessing the GSS server 140. The computing devices 110 access the GSS server 140 via a GSS mobile application running on mobile computing devices 110 or a web interface provided by GSS server software running on GSS server 140 via web browsers included on computing devices 110. A server computer includes software and hardware for providing the functionality and features described herein. A server computer may include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). Certain portion of the methods, functionality and features described herein are embodied in software which operates on a server computer and may be in the form of firmware, an application program, an applet (e.g., a Java applet), a browser plug-in, a COM object, a dynamic linked library (DLL), a script, one or more subroutines, or an operating system component or service.

The GSS techniques may be implemented in software and stored on a machine readable storage medium in a storage device included with or otherwise coupled or attached to the GSS server 140, computing devices 110 and GSS local system 130. That is, the GSS software is stored on machine readable storage media. These storage media include various kinds of physical media, namely: magnetic media such as hard disk drives (HDDs); optical media such as compact disks (CD-ROM and CD-RW) and digital versatile disks (DVD and DVD±RW); silicon media such as solid-state drives (SSDs) and flash memory cards; and other magnetic, optical or silicon storage media. As used herein, a storage device is a device that allows for reading and/or writing to a storage medium. Storage devices include hard disk drives, DVD drives, SSDs, EEPROMs, flash memory devices, and other magnetic, silicon, optical or other physical media.

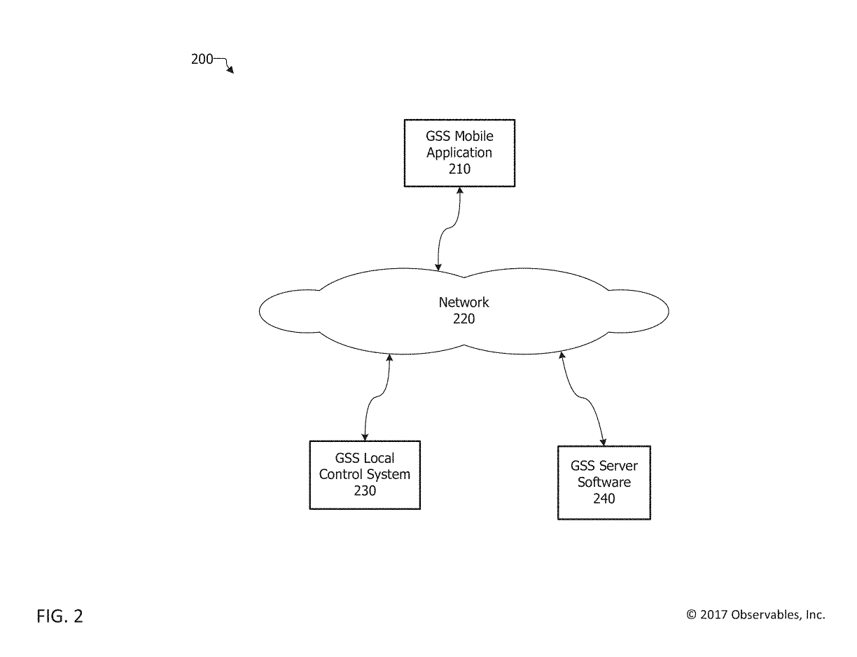

Referring now to FIG. 2, there is shown a block diagram of a general software configuration of the generalized security system described herein. This discussion also includes reference to FIG. 1 The GSS includes GSS server software 240 on a server 140 that includes GSS website and mobile application support software. The GSS includes a GSS mobile application 210 running on mobile computing devices 110. The GSS 210 mobile application receives configuration, control commands and other information from users and communicates them over network 220 to the GSS website and app support software of the GSS server software 240 running on the GSS server 140. The GSS server software 240 includes a GSS local system support software that communicates with GSS local system software 230 at GSS local systems 130 over networks 120 and 220. The GSS server software 240 GSS local system support software that communicates control, configuration and command information to and receives external device data, alerts and other security device information from GSS local system software 230.

The GSS local system takes inventory of all connected external devices and components, and external systems upon startup. The software in the GSS local system is programmed to recognize and communicate with multiple differing security system components and devices and systems provided by a multitude of manufacturers. Example components and manufacturers include: alarm panels and key pads from Honeywell International, Inc., NetworX Systems, LLC, DMP—Digital Monitoring Products, Inc. and DSC—Digital Security Controls from Tyco Security Products; access readers that use the Wiegand interface and protocol or Open Supervised Device Protocol (also known as ASDP) such as those from Rosslare Security Products, Inc.; and phones and intercoms from Viking Electronics, Inc.; and others. The GSS server provides an easy to use graphical interface via a web interface and associated mobile application that provides users the ability to view, monitor, configure and control the external devices, components and systems coupled with the GSS local system. In this way, users of the GSS do not have to have knowledge of the communication requirements and lower level functionality of the external devices, components and systems coupled with the GSS local system. The external devices components and systems include, for example, door controllers, alarm panels, keypads, keycard readers, badge readers, man-traps, virtual wires, tamper detectors, biometric devices such as ophthalmic and fingerprint readers, temperature sensors, fire alarms, light sensors, motion sensors, water sensors, humidity sensors, window state sensors, audio sensors, earthquake sensors, accelerometers, door sensors, glass break sensors, video cameras or sensors, and others. The local system accommodates as external components virtually any sensor that communicates via a voltage, current, resistance, or communication bus message.

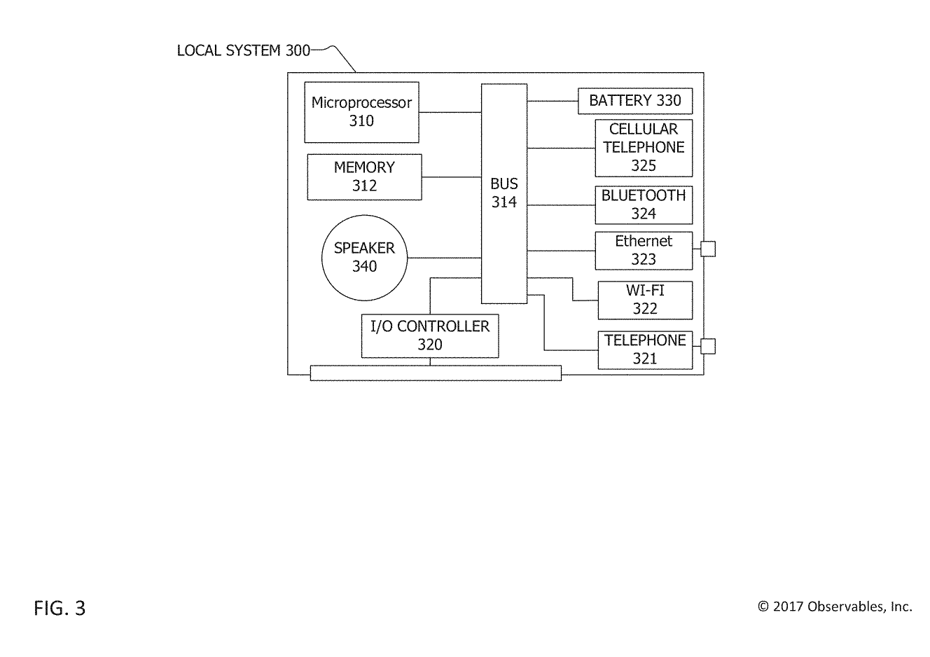

Referring now to FIG. 3, there is shown a block diagram of an example local system controller board 300 that implements a portion of the generalized security system described herein. The local system controller 300 may be a single board having multiple components that support the local system portion of the GSS. The controller may include multiple boards. The local system controller 300 includes a microprocessor 310 to execute instructions or software stored on a storage device 312 that implements the local system support software of the GSS including at least one state machine, one or more of which may include a responder engine. The storage device 312 may be a ROM, EEPROM, flash memory and the like. The GSS local system controller board 300 includes electronics and software that allows for communicating with the GSS server and with external security systems and security system components. The GSS local system controller board 300 includes electronics and software in the form a telephone system component 321, a cellular telephone component 325, a WIFI component 322, an Ethernet component 323 and a Bluetooth component 324 that allows for communicating with a GSS server 140/240 or to devices and systems through which communications are made with a GSS server 140/240 over network 120/220 such as, for example, an Internet router, a cell phone, satellite communications, microwave transmissions, and others. The GSS local system controller board 300 includes electronics and software in the form of an I/O controller 320 (which may be a general purpose input/output controller or GPIO controller), a WI-FI component 322, an ETHERNET component 323 and a BLUETOOTH component 324 that allow for communicating with external devices near the local system, such as fire alarms, smoke detectors, door sensors, window sensors, motion sensors, proximity sensors and other security system and monitoring system components, devices and control panels available from multiple manufacturers. All of the components in the controller 300 may communicate over a single bus 314 or over multiple internal buses or other communication lines. Alerts may be provided via an audio speaker 340 and lights such as LEDs (not shown) on a box or external unit encasing the controller 300. The controller 300 has physical connectors that allow for connection to landline telephone, Ethernet cable, and a myriad of security devices and control panels.

Description of Processes

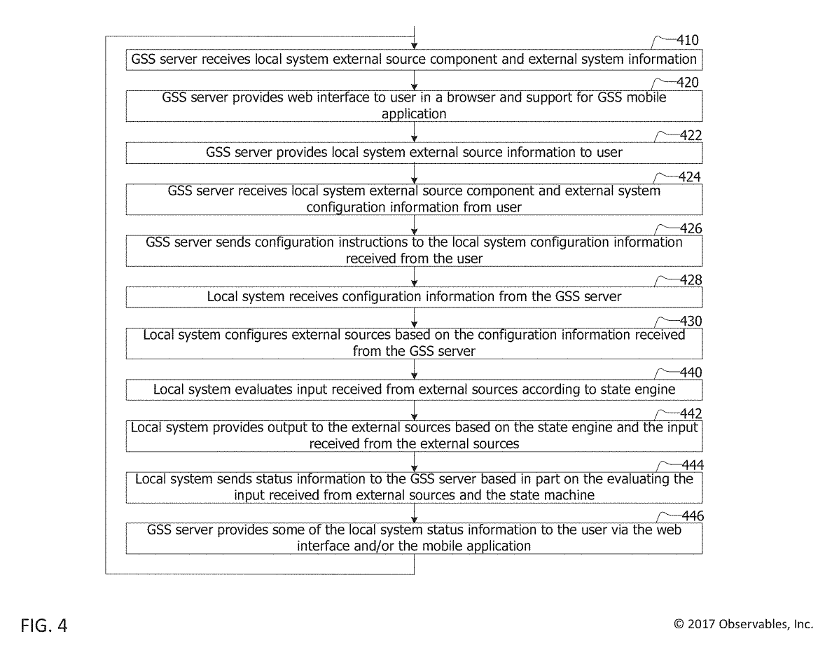

Referring now to FIG. 4, there is shown a flow chart of actions taken in the generalized security system described herein. When a local system is installed, external components and external systems are connected via wired connections and/or wirelessly using the communication components of the local system controller. The connections may be made using BLUETOOTH, WI-FI, ETHERNET, direct wired connection, and others. The local system may initially, upon power on, identify the external sources or take an inventory of attached or connected external devices and systems. This may also include communicating with a third party central monitoring station. Certain initial configuration of the local system may be performed on site. The local system is typically connected to a network such as the Internet via WI-FI or direct ETHERNET connection, while other connections are possible. The local system checks in with and registers with the GSS server. The GSS server receives local system external source component and external system information over a network from the GSS local system, as shown in block 410. The GSS server provides web interface to user in a browser and support for GSS mobile application, as shown in block 420. The GSS server provides local system external source information to a user, as shown in block 422. This is achieved via the GSS server web interface or the GSS mobile application. Easy-to-read web pages and mobile application pages allow the user to review the external components and external system connected with the local system. The user may specify external components and external system configuration information including, for example, thresholds and parameters such as temperature and humidity, active times, time on, time off, and many others. The web interface and mobile application provide users the ability to specify the configuration and behavior of external components and systems connected with the local system and the local system itself which are reflected in the state engines described below. The GSS server web interface and the GSS mobile application may provide higher level question/answer wizards to make it relatively easy for users to configure the local system and the external components and system attached to the local system. The GSS server web interface and the GSS mobile application may also provide an interface that allows the user to provide lower level configuration settings for the external components and external systems coupled with the local system. The GSS server web interface and the GSS mobile application provide a graphical user interface that allows users to specify configuration information including time-based behavior such as start time or date, end time or date, repeat frequency, interval between events, or hysteresis as well as logical behavior such as “and”, “or”, or “not”. The user specified configuration includes data or configuration information from external components, events created by or through external components, or events created by or through the server. Preconfigured lists of information, such as predefined common thresholds, common business hours, users, groups, schedules, and holidays may be provided as part of the wizard or other graphical user interface to ease the configuration of the local system and/or the GSS as a whole.

The GSS server receives over the network local system external source component and external system configuration information from user via the GSS server web interface or the GSS mobile application, as shown in block 424. The GSS server sends configuration instructions to the local system based on configuration information received from the user, as shown in block 426. The local system receives configuration information from the GSS server over the network, as shown in block 428. The local system is programmed via configuration instructions and information in the form of metadata sent by the GSS server describing state engine configuration and that information only comes from one or more known GSS servers. This makes the GSS secure as the local system only accepts inbound remote connections and code deployments from known GSS servers.

The local system configures external sources based on the configuration information received from the GSS server, as shown in block 430. The local system sets thresholds, times and other configuration information for connected external components and external system based on the configuration information the user provided. The local system evaluates input received from external sources according to state engine, as shown in block 440. The input may include a temperature measurement, an analog voltage measurement, a digital voltage measurement, a resistance measurement, position data, motion data, button data, switch data, card reader data, fingerprint data, ophthalmic data, a digital message, results of a ping, results of a network scan, results of a component awake or component on query, and others. The local system provides output to the external sources based on the state engine and the input received from the external sources, as shown in block 442. This output includes various control information and thresholds such as time and temperature, for example. The local system receives status information from external components and external systems. The local system sends status information to the GSS server based in part on the evaluating the input received from external sources and the state machine, as shown in block 444. The GSS server provides some of the local system status information to the user via the web interface and/or the mobile application, as shown in block 446, which may include sending text message alerts, central monitoring station messages, email alerts, a SIP communication, a local network message, and other high priority information via one or more user specified communications techniques.

The local system includes software that implements or includes a state machine. In the state machine, a flow is a set of states, containing rules, governed by inputs, and producing outputs. A flow contains a map of states, keyed by the StateID. Each flow may contain an ordered list of rules that are executed from any state. A flow tracks the current state and last state change time and allows for custom storage of key-value pairs for rules to persist data. Multiple flows may be supported. A state is a position in a flow. Each state contains an ordered list of rules that are executed when in that state. A rule is a condition that depends on inputs of the local system and results in a true, false, or indeterminate evaluation. If a rule evaluates to true, associated outputs are communicated and/or the local system current state is changed. A container rule is a special type of rule that contains one or more other rules and bases its condition on the conditions of the contained rules. Container rules may be nested. An input is any aspect of the local system that changes independently and whose properties can be measured, typically signals, data, messages or status the local system receives from connected external components and external systems. Example input includes GPIO pin signals, motion detection signals and status, temperature, time, elapsed time since a particular event or occurrence, and others. An output is any aspect of the local system that can be set or controlled by the local system, typically configuration information and instructions or commands to connected external components and external systems. Output examples include send message to GSS server, send message to central monitoring station server, send GPIO pin signal, send email, send text message, send SIP communication, send local network message, set local system LED on or off, send command signal to unlock door, send command signal to trigger an audio alarm, send command signal to trigger a visual alarm, and others. An output from the local system may also be an input to an external system, external component or the GSS server.

Referring to the prior paragraph, example rules include: evaluating if pin is high or a signal code receive, then enter a particular state; evaluating if a temperature is outside of a predefined or user specified range, then issuing a command to turn on a heater and/or sending an alert communication to the GSS server; evaluating if a time since a last transition then taking a pre-defined or user specified action; evaluating if a signal or pin or combination of signals and pins from one or multiple external components is high while another is also high then taking a predefined or user specified action. The predefined actions may be specified by the manufacturer and provided in the local system. User specified actions may be provided by a user via the web interface or mobile application to the GSS server which communicates them to the local system.

The state engine is dynamically built at run-time by the local controller in the local system from a configuration file in memory on the circuit board. This configuration file is created from data supplied by the GSS server based on information specified by a user via the GSS web interface or the GSS mobile application. To construct the state engine dynamically, each output class and rule class is associated with a unique identifier. The dynamic configuration file contains for each flow: (1) Each of the states to be created, along with its name and identifier; (2) Each rule to be created, along with its class type, child rules (as needed), associated state, state to transition to if the rule is true (as needed), and a string with its encoded parameters (as needed); (3) Each output to be created, along with its class type, associated rule, and a string with its encoded parameters (as needed); and (4) The initial state of the state engine.

The state engine may include or be augmented by software that referred to as a responder engine. The responder engine responds to signals via a queue, polling, or interrupt process, and includes responder rules, filters, and outputs. For each signal, responder rules are evaluated. If the signal passes all the filters, then the outputs for that responder rule are executed. The responder engine operates in a repeating loop capturing inputs from external components and external systems and causing the local system to take action in response to those inputs. The responder engine selects actions to take based on parameters set by filters. Inputs to the responder engine include, for example, network communications requests such as TCP/IP or TCP/UDP requests including HTTP POSTS; user inputs, such as user codes entered on a key pad, card reader input, biometric data; device inputs, such as alarm messages from an external system alarm panel; and GSS server inputs, such as change notifications, requests or information provided by a user via the web portal or mobile application. The responder engine may initiate actions corresponding to the output types listed above, including changing the current state of a flow, changing the mode of an external component or external system, and others. The filters accessed by the responder engine are criteria that limit or specify trigger events. Filter criteria include, for example, the type of input event, value or values of elements contained in the input event data; the rate of occurrence of input events (for example, how often a door opens and closes).

Based on the prior paragraphs, the configuration information obtained by the GSS server and sent to the GSS local system includes user specified external devices to be included in the system, user specified external device parameters and thresholds, and state engine specifications, wherein the state engine specifications include flows, states, rules, filters, outputs, and responders.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system comprising:
a local system including at least one microprocessor, at least one network communication component, the local system in communication with a remote server via the network communication component, at least one input component to receive input from multiple external sources provided by multiple different manufacturers, local software stored on a local storage device, the local software including a state engine which when executed causes the local system to perform operations including:
identifying the external sources;
receiving configuration information from a server,
configuring external sources, as needed, based on the configuration information received from the server,
evaluating the input received from the external sources,
providing output to the external sources based on the state engine and the input received from the external sources,
sending local system status and external source information to the server based in part on evaluating the input received from external sources and the state machine.

2. The system of claim 1 wherein the configuration information from the server includes at least one of user specified external devices, user specified external device parameters and thresholds, state engine specifications, wherein the state engine specifications include some selected from flows, states, rules, filters, outputs, and responders.

3. The system of claim 1 wherein the state engine includes:
a plurality of state objects, one of the state objects designated as a current state at any given time;
a plurality of input objects that have values based on external or internal signals;
a plurality of rule objects associated with a state with a value that depends on the values of input objects or other rule objects;
a plurality of output objects associated with a rule that can control or signal external or internal devices;
wherein the state engine operates in a repeating loop, evaluating the rules of the current state, triggering output objects based on the rule object values, and changing the current state according to the rule objects.

4. The system of claim 1 wherein the input received from the external sources include at least three selected from the group including: a temperature measurement, an analog voltage measurement, a digital voltage measurement, a resistance measurement, position data, motion data, button data, switch data, card reader data, fingerprint data, ophthalmic data, system on query results, component on query results, ping results, and a digital message.

5. The system of claim 1 wherein the output provided to the external sources includes at least three selected from the group including: LED control command, digital voltage output, analog voltage output, pulse modulated signal output, relay control command, door or lock control command, Internet message, SIP communication, local network message, text message, voice message, sound generator, monitoring center message.

6. The system of claim 1 where the external source is at least three of a door controller, an alarm panel, a keypad, a man-trap, a card reader, a retina reader, a temperature sensor, a smoke sensor, a fingerprint reader, an analog phone, a SIP phone, a virtual wire, or a tamper detector.

7. The system of claim 1 wherein the local system further includes an input connector that enables the user to directly provide local system and/or external source configuration information.

8. A system comprising a server having instructions stored thereon which when executed cause the server to perform the actions including:
receiving over a network configuration information for a local system and external components and external systems coupled with the local system from a user accessing a web interface to the server or a mobile application in communication with the server;
sending over the network configuration instructions to the local system for local system features and/or the external components or external systems coupled with the local system based on the configuration information received from the user;
receiving status information from the local system regarding the external components and external systems;
evaluating the status information;
providing over the network at least some of the status information to the user via the web interface and/or the mobile application

9. The system of claim 8 wherein the configuration information includes at least one of user specified external devices, user specified external device parameters and thresholds, and state engine specifications, wherein the state engine specifications include some selected from flows, states, rules, filters, outputs, and responders.

10. The system of claim 8 wherein the input received from external sources include at least three selected from the group including: a temperature measurement, an analog voltage measurement, a digital voltage measurement, a resistance measurement, position data, motion data, button data, switch data, and a digital message.

11. The system of claim 8 wherein the external components include at least three selected from the group including: LED controller, digital voltage output, analog voltage output, pulse modulated signal output, relay controller, door or lock controller, Internet message, text message, voice message, sound generator, monitoring center message.

12. The system of claim 8 where the external components include at least one of a door controller, an alarm panel, a keypad, a man-trap, a virtual wire, or a tamper detector.

13. The system of claim 8 wherein the server includes further instructions which when executed cause the system to perform further operations including:
providing the web interface to the user, the web interface including a configuration wizard that provides the user with pre-defined options and adjustable parameters for the local system, the external components and the external systems.

14. The system of claim 8 wherein the server includes further instructions which when executed cause the system to perform further operations including:
providing messaging to a central monitoring station.
